(19) United States
(12) Patent Application Publication
(10) Pub. No.: US 2006/0200279 A1
(43) Pub. Date: Sep. 7, 2006

(54) Method of determining a comparison of an aircraft's performance capabilities with performance requirements

(76) Inventors: Robert James Ainsworth, Dunwoody, GA (US); John David Dishman, Atlanta, GA (US)

Correspondence Address: ROBERT JAMES AINSWORTH, 1916 VILLAGE CREEK COURT, DUNWOODY, GA, 30338, US

(21) Appl. No.: 11/071,145

(22) Filed: Mar. 3, 2005

(51) Int. Cl. G06F 19/00

(52) U.S. Cl. 701/16; 340/951

(57) ABSTRACT

A method for providing an indication of the capability of an aircraft to dissipate altitude (20) and speed (12) in comparison with descent and deceleration requirements necessary to establish stabilized flight conditions prior to landing on a runway. By referencing a shortest flyable path to a target point (10) and subsequently to the runway, the present invention provides a method to evaluate energy state, independent of any predetermined flight path. Tangible scaling (16) of output values provides an indication of the effects of subsequent maneuvering and deployment of aircraft devices in usable terms that can be directly applied without further interpretation or conversion.

### FIELD OF THE INVENTION

The present invention relates to the management of aircraft speed, altitude, and configuration during descent and deceleration for an arrival, approach, and landing, and more particularly to the relationship between the manuevering required to be established on stabilized predetermined flight conditions prior to landing and an the performance capability of an aircraft to perform required maneuvers.

### BACKGROUND OF THE INVENTION

Currently no device or process is available that produces a useable relationship of an aircraft's performance capabilities with the performance requirements to establish stabilized flight conditions on approach, prior to landing, that is independent of any predetermined lateral flight path or vertical flight profile. The management of aircraft descent and deceleration, in the airport terminal airspace, to a point where a safe and stabilized approach to a landing, is most often the result of repetitive mental estimations. Greater than desired speed and/or altitude with respect to remaining flight path distance to a runway of intended landing has been recognized throughout the aviation industry as a leading precursor of landing incidents and accidents.

With no device or process available, airlines and other aircraft operators have developed manual criteria for aircraft configuration, as well as speed and altitude, at a point prior to and above the landing runway in effort to mitigate landing incidents and accidents. An example specifies final checkpoints at 1000 feet above touchdown for instrument approaches (or 500 feet for visual approaches) where the aircraft is required to be established and stabilized on the final approach speed, landing gear and flaps set for landing, aligned with the runway centerline, engine thrust set for approach and established along a vertical approach descent path to the runway touchdown zone (a descent angle usually equal to, or approximately, 3° below level flight). These criteria are intended to preclude the continuation of an approach with unstable flight conditions or with an excessive energy state (defined as a speed and/or altitude in excess of a given aircraft's performance capabilities to dissipate over the distance remaining). However, post-flight analyses have determined that excessive energy states at these final checkpoints is not uncommon and most often results from earlier energy states during the arrival phase that approach or exceed the performance capabilities of the aircraft.

One industry study shows that even the newest aircraft equipped with the most modern automated and display equipment in service continue to encounter high and excessive energy states on arrival. Post flight data analysis of aircraft including Boeing 777, 767, 757, 737-800, Airbus A320 series, A330, and A340 aircraft show that nearly one in five of the approaches performed by these aircraft (even those equipped with Flight Management Systems, Global Positioning Systems and Heads Up Displays) result in a substantial deviation of one or more of criteria specified for stabilized approaches.

High and excessive energy states during the arrival phase, preceding an approach to a landing, occur for a variety of factors. When arriving in the vicinity of the destination airport, aircraft energy states (speed and altitude in relation to distance to touchdown) are often predetermined by factors including air space boundary, air traffic separation and terrain clearance requirements. Published arrival routing, as well as vector clearances by air traffic controllers, can specify waypoint altitude and/or speed constraints that may not consider, and occasionally exceed, descent and deceleration capabilities of participating aircraft. As a result, aircraft under these conditions often fail to meet criteria for stabilized approaches at the specified check points.

With no prior existing useful determination or display of aircraft energy state, terminal area management of aircraft energy during the arrival phase of flight is most often accomplished through manual estimations by the pilot in all varieties of aircraft, including those equipped with the most modern automated guidance and display devices.

A commonly used technique for mitigating excessive aircraft energy states near a destination airport relies on mentally performed estimations based on a commonly used rule-of-thumb which recommends jet transports arrive 30 nautical miles from and 10,000 feet above the destination airport at an indicated airspeed of 250 knots. Manual estimations of aircraft energy state throughout the arrival phase and approach rely on mental calculations, based on descent and deceleration rules-of-thumb (e.g., 1000′ of descent for every 3 nautical miles traveled and a deceleration rate of 10 knots of per nautical mile). To remain relevant, this process must be continuously repeated throughout the arrival. The accuracy of this mental-math process is compromised not only by the errors inherent in the initial rule-of-thumb, but is additionally aggravated by factors including; intervening air traffic clearances, weather, terrain, published waypoint speed/altitude requirements, shifting winds, and an undetermined flying distance to landing (particularly where curved paths as a result of turns are required to align with the runway). As a result, it is not uncommon for aircraft to arrive at the 1000′ and 500′ final checkpoints in non-compliance with some or all of the specified criteria for a stabilized approach.

On aircraft equipped with Flight Management Systems FMS) and other area navigation devices capable of Vertical Navigation (VNAV), pilots can be provided with descent management symbology and text that indicate deviation from a calculated profile, but only to a point located along an entered and predetermined route. Though FMS VNAV can provide guidance and deviation indications to programmed waypoints along the programmed route, no method or device exists that assures the speed and altitude specified at these waypoints are within the aircraft performance capabilities to be established on stabilized conditions prior to landing. In fact, the programming, in to an FMS, of speed and altitude constraints on an arrival is often a frequent cause of excessive and unstable aircraft energy states.

Due to lateral and vertical vectoring, employed by air traffic control, in part, to ensure required separation and to maximize traffic capacity, the likelihood of an aircraft actually tracking any programmed route from an arrival throughout an approach and landing is very rare, if not unfeasible. The impracticality of continued manual re-entry of routing under dynamically changing conditions often creates crew workload levels that impede or preclude the continued use of FMS during an arrival phase. In the rare event that an aircraft were to fly a programmed FMS route throughout the arrival and approach (a single path in the spectra of possible flyable paths to a specified runway), crew would not be informed as to whether the energy state including altitude and/or airspeed) at any point along the flight path would allow for operator specified stabilized conditions prior to landing. Moreover, manual manipulation of pre-programmed approach routing, such as entering a point over the earth coincident with specific altitude (e.g., 1000 feet above landing touchdown), for the intention of obtaining guidance for compliance with stabilized approach criteria, can corrupt pre-programmed guidance data on many FMSs and is thus restricted by many operators.

In U.S. Pat. No. 4,825,374 by King, et al, guideslope information is determined in reference to a speed and altitude at a waypoint located on a programmed flight path. The description of this invention places the process within FMS equipment. Though vertical guidance to the waypoint is provided, even if the aircraft is not on the programmed path, this guidance is only valid for flight paths directly to the waypoint. Curved paths to the waypoint yield a longer distance flown and are not accounted for, nor provided, by this method. Additionally, as stated earlier in description of FMS devices, this method also does not assure the speed and altitude specified at waypoints along an arrival or approach are within the aircraft performance capabilities to be established on stabilized conditions prior to landing.

The following U.S. patents disclose various methods for display and guidance of predetermined vertical flight paths employed by FMS and other area navigation systems with VNAV functionality, none of which factor the aircraft performance capabilities or flight path requirements for stabilized conditions in relation to an approach to landing, as previously discussed; U.S. Pat. No. 4,012,626 by Miller, produces a pitch command signal for controlling the vertical flight of the craft on a predetermined vertical flight path; U.S. Pat. No. 4,792,906 by King, et al, provides a geometric display to the pilot of the vertical position of the aircraft relative to a selected vertical flight path profile; U.S. Pat. No. 4,021,009 by Baker, et al, provides a method for the vertical path control for aircraft area navigation systems. Additionally, the scaling of deviation from the path, determined by these devices, is expressed in terms of raw vertical distance of the deviation, without respect to the flight distance remaining. Thus, the raw output of a given deviation remains constant, though the performance required to dissipate this deviation increases as remaining flight distance diminishes.

In NASA document ARC-15356-1, September 2004, titled, “Energy Index For Aircraft Maneuvers”, a comparison index is produced that compares a measured or estimated aircraft total energy (comprised of kinetic energy and potential energy) with a hypothetical reference total energy. Similar to FMS VNAV methods, previously cited, this invention also does not provide a valid reference total energy that can be useable in flight for the following reasons: The formulation of reference total energy, which requires a vertical angle of flight (a function of distance and altitude), does not provide methodology for determining this vertical angle (or distance), thus any reference total energy provided by this invention can only be based on arbitrary or hypothetical assumptions of this angle. Additionally, by not providing a method for determining the length of a flight track an aircraft will take from its present position to a target point, this invention cannot provide a valid reference total energy in real time. Further, by not relating the measured/estimated or reference total energies to the aircraft's performance capabilities, this method can present an output that indicates the measured/estimated total energy is equal to the reference total energy, yet speed and altitude may still be too great for an aircraft to dissipate to obtain desired stabilized flight conditions by a specified point. Additionally, by basing the method on raw kinetic and potential energy, this invention provides output in terms of foot-pounds or joules, which does not provide output scaled to tangible configurations of aircraft devices (e.g., flaps, speed brakes, landing gear) necessary in conveying what corrective actions could be performed to regain a desired energy state in terms useable by aircraft operators. This non-tangible output requires a further interpretation by its intended users to convert this output to a meaningful value that can be related to aircraft maneuvering and/or the deployment of aircraft devices.

Currently available devices and processes do not provide mitigation for the issue of high or excessive energy during aircraft arrival, approach, and landing. Industry studies, based on recorded flight data, continue to show the exceedence of desired parameters for stabilized approach and landing to be the among the most common of non-normal flight events.

It is therefore an object of the present invention to provide a method to determine and display a useable indication of the relationship between an aircraft's performance capabilities and performance requirements to establish stabilized flight conditions on approach, prior to landing, throughout the spectra of possible lateral and vertical paths to a runway.

It is another object of the present invention to determine and display this relationship of aircraft performance capabilities and requirements with a tangible scaling of output values that correspond to aircraft devices (e.g., speed brakes, landing gear, flaps) and recognizable parameters (e.g., speed, altitude, distance). Tangible scaling of output values provides an indication, not only of the limits of an aircraft's ability to dissipate altitude and speed for a given set of conditions, but the effects of subsequent maneuvering and deployment of aircraft devices.

It is another object of the present invention to determine and display this relationship of aircraft performance capabilities and requirements with output values that factor remaining flight path distance, such that the output represents the performance required to dissipate a deviation, as opposed to raw deviation scales which remain constant for a given deviation, though the performance required to dissipate a deviation increases as remaining flight distance diminishes.

It is another object of the present invention to determine the minimum distance flight path to a runway of intended landing, independent of any predetermined or actual flight path, which yields the shortest flyable path to a stabilized approach to the runway which provides in an output corresponding an energy state which cannot increase as a result of lateral maneuvering. This shortest flyable path, in conjunction with the relationship of aircraft performance capabilities and requirements, also provides the basis for the determination of arrival and approach profiles which maximize fuel economy and/or minimize flight time.

It is another object of the present invention to provide indications based on aircraft performance capabilities and performance requirements, thus providing output in terms that can be applied by aircraft operators the management of aircraft in flight.

### SUMMARY OF THE INVENTION

The present invention overcomes the limitations of the prior art by providing an indication of the capability of an aircraft to dissipate altitude and airspeed in comparison with the descent and deceleration requirements necessary to establish stabilized flight conditions prior to landing on a runway. By referencing the flight track distance to the runway, as opposed to a predetermined route or path, the present invention provides a method to evaluate the energy state of any predetermined or actual flight path.

According to one aspect of the present invention, the tangible scaling of output values provides an indication of the relation between a given aircraft energy state and the limits of its ability to dissipate altitude and speed for a given set of conditions. Tangible scaling also provides indication of the effects of subsequent maneuvering and deployment of aircraft devices in usable terms that can be directly applied by aircraft operators, and other users, the management of aircraft in flight, without further interpretation or conversion.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a flow chart view of a flow chart describing the functional steps for the calculation and output of the energy index in accordance with the invention;

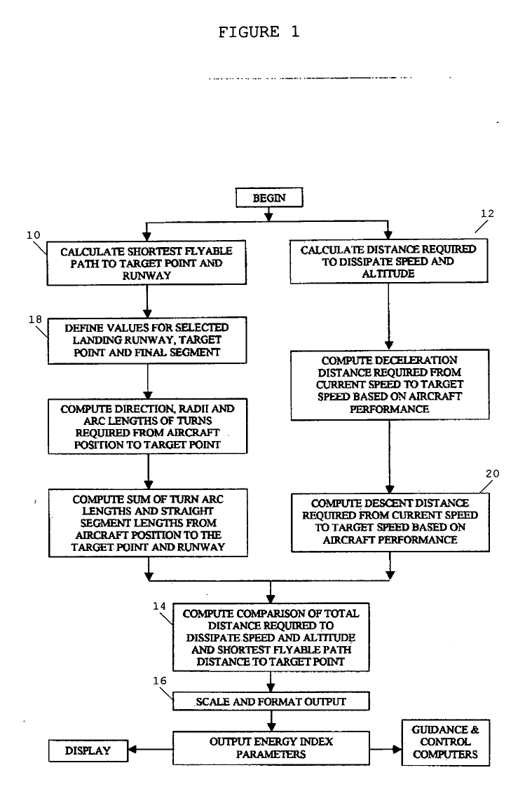

FIG. 2a is a top view of a construction of the path to the runway and the determination of the direction, radius and placement of the turn to the final segment;

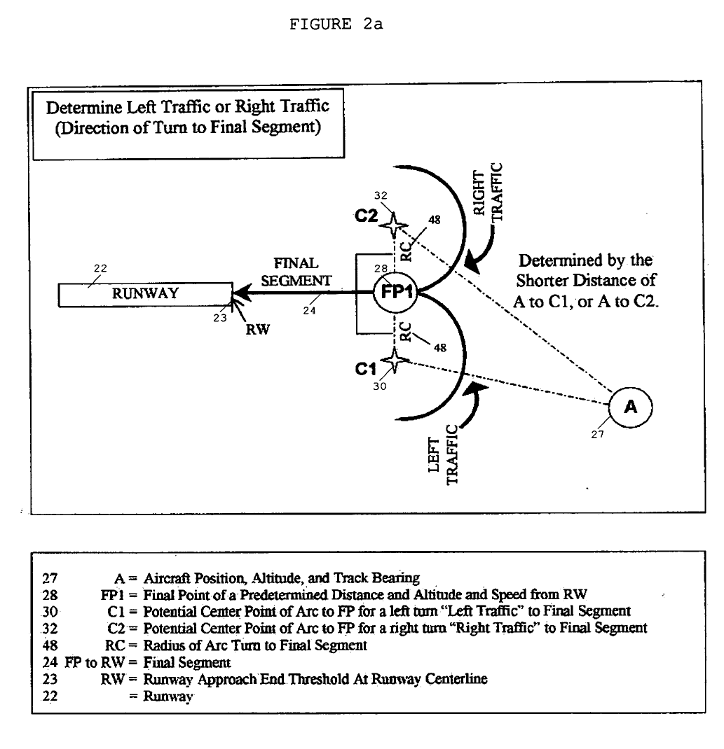

FIG. 2b is a top view of a construction of the path to the runway and the determination of the direction, radius and placement of the turn to the base segment and the determination of the tangent points of the two turns that define the base segment where both turns are in the same direction;

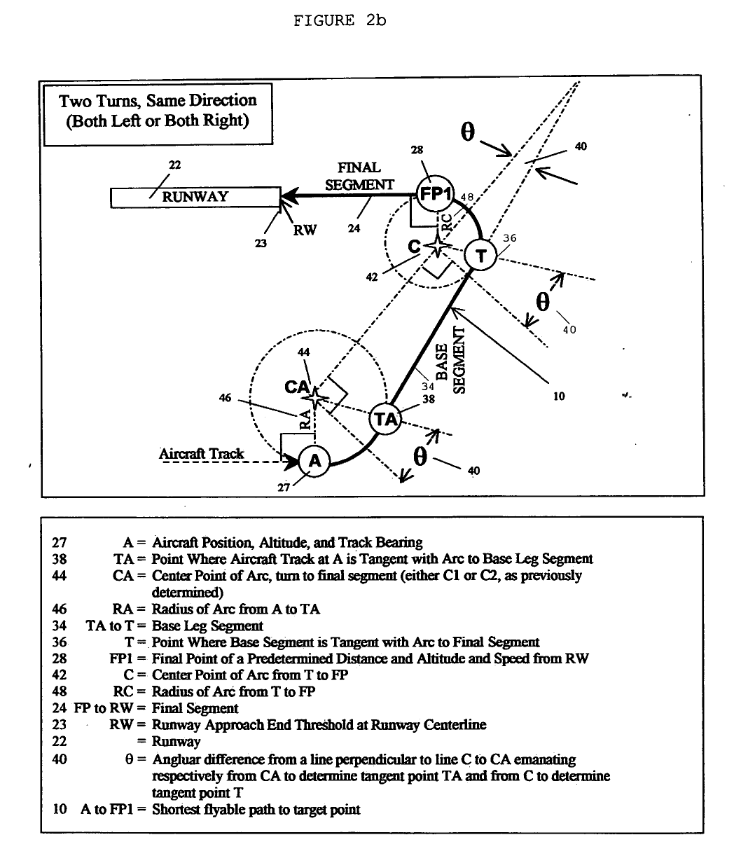

FIG. 2c is a top view of a construction of the path to the runway and the determination of the direction, radius and placement of the turn to the base segment and the determination of the tangent points of the two turns that define the base segment where both turns are in the opposite direction;

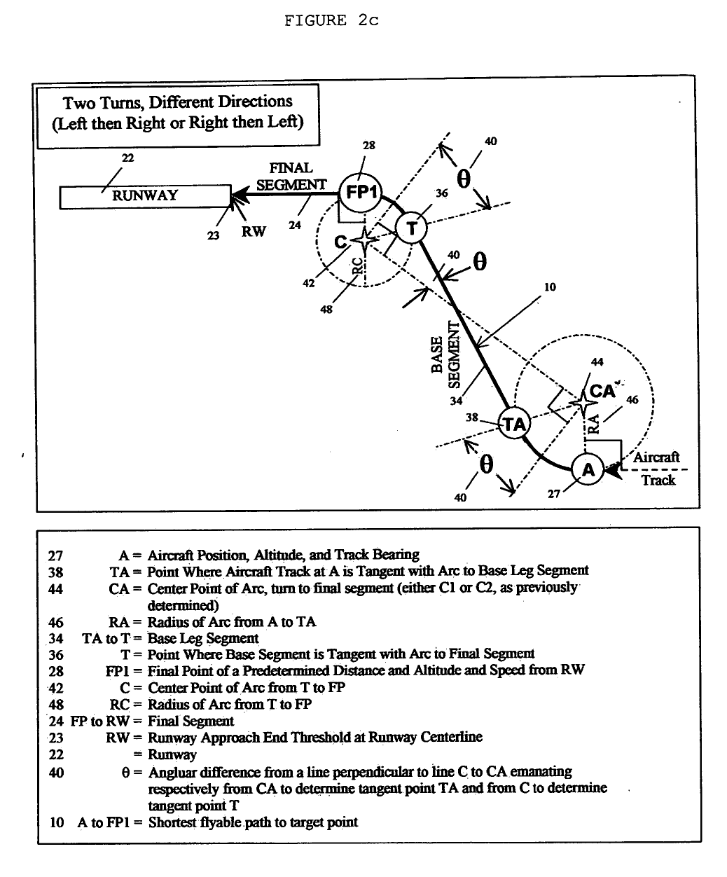

FIG. 3a is a side view of a profile depicting the value of the Energy Index for a given speed, landing gear configuration and flap configuration at a given altitude above, and calculated minimum flight distance to, the runway;

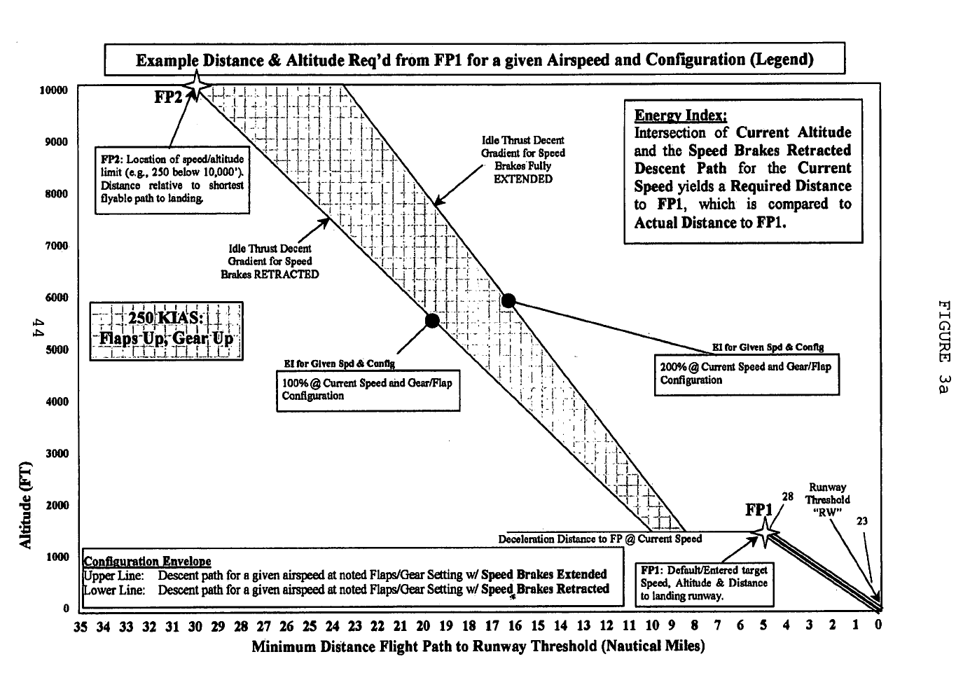

FIG. 3b is a side view of a profile depicting the value of the Energy Index for several given speeds, landing gear configurations and flap configurations at a given altitude above, and calculated minimum flight distance to, the runway, for altitudes below 10,000 feet; and

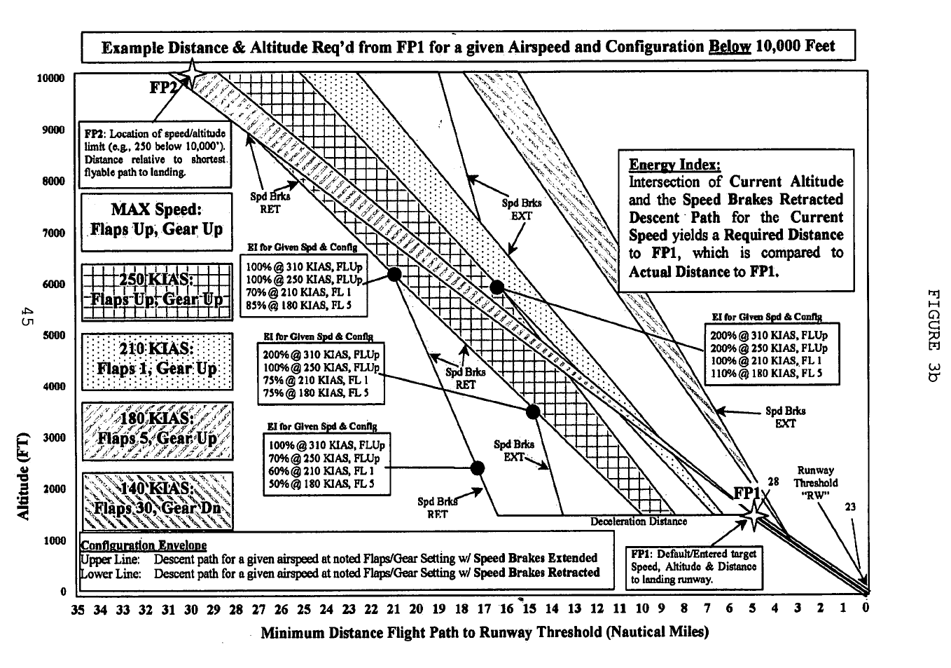

FIG. 3c is a side view of a profile depicting the value of the Energy Index for several given speeds, landing gear configurations and flap configurations at a given altitude above, and calculated minimum flight distance to, the runway, for altitudes above 10,000 feet.

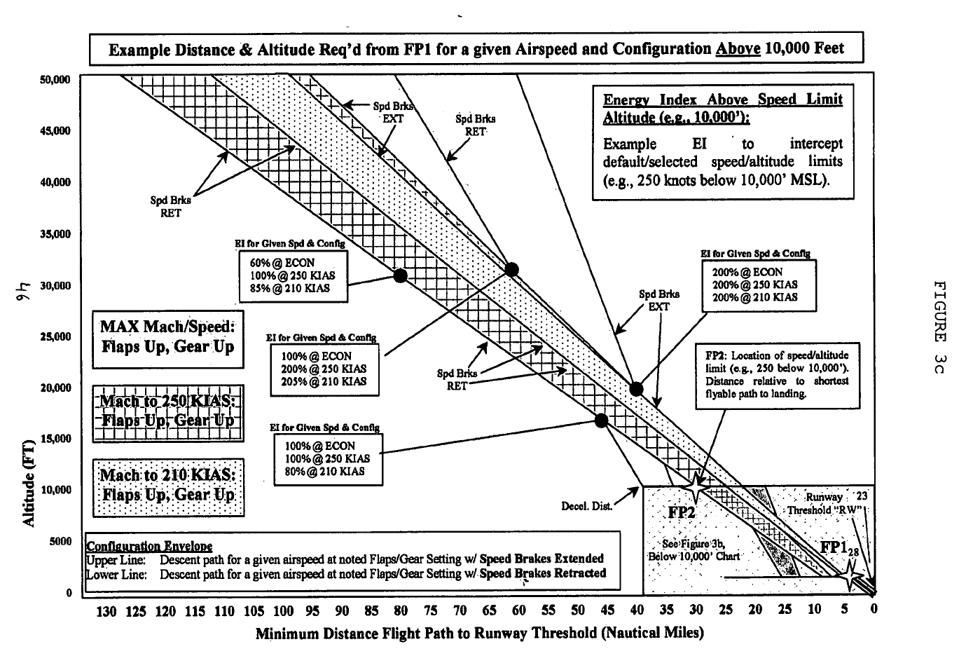

For purposes of clarity and brevity, like elements and components will bear the same designations and numbering throughout the FIGURES.

### DESCRIPTION OF THE PREFERRED EMBODIMENT

I. Introduction

The present invention comprises a method for conveying Energy Index 50, which is defined as a comparison of an aircraft's ability to dissipate speed and altitude, with deceleration and descent requirements necessary to obtain a desired speed, altitude and aircraft device configuration 14 (e.g., flaps, landing gear) at a predetermined Target Point 18 prior to landing.

Where as prior art provides displacement from a predefined and fixed flight path to predetermined navigational waypoints, prior art does not compute descent or deceleration requirements to Runway 22 an aircraft will ultimately land on. The present invention overcomes the limitations of prior art by dynamically calculating Shortest flyable path to Target Point 10, which includes Target Point 18 of a predetermined distance from and altitude above Runway 22, as well as a predetermined speed, for the purpose of providing stabilized flight conditions on Final Segment 24 of the approach, immediately prior to landing. The present invention further overcomes limitations of prior art with Tangible Scaling 16 and formatting of output in terms related to aircraft descent and deceleration capabilities.

II. Computation OF Energy Index 50

Computation of the present invention is accomplished by the following algorithm:

1. Define parameter values for Runway 22, (RW 23), a Target Point 18 (FP1 28), Final Segment 24, and an aircraft position, a bearing of track (“A” 27) and a velocity (VA 62)

a. Point RW 23 is defined as Runway 22 position (in latitude and longitude), and elevation (above mean sea level) corresponding to the intersection of Runway 22 centerline and Runway 22 approach threshold. RW 23 also includes Runway 22 heading, defined as a bearing along Runway 22 centerline from Runway 22 threshold.

b. Point FP1 28 is defined as a position aligned with a extended centerline of Runway 22, at bearing 180 degrees from Runway 22 and with defined distance from, and elevation above point RW 23, and a defined speed VC 60.

c. Line Final Segment 24 is defined as a bearing and a distance between point FP1 28 and point RW 23.

2. Compute direction, radii and arc lengths of turns required from aircraft position “A” 27 to Target Point 18 FP1 28 and Runway 22 RW 23.

a. Calculate location of a point “C” 42 (defined as a center point of a turn to Final Segment 24 from Base Segment 34).

i. Point “A” 27 is defined as aircraft position (in lattitude and longitude), altitude (above mean sea level), bearing of aircraft track, and velocity.

ii. A minimum radius RC 48 is defined as a turn radius to Final Segment 24 based on predetermined speed VC 60 and a predetermined bank angle B, where RC 48=VC 60ˆ2/(11.23* tan(0.01745*B)).

iii. Point “C” 42, is determined by first creating two potential center points of turn to Final Segment 24, a point C1 30 and a point C2 32, which are both located at distance RC 48 from Final Segment 24 at point FP1 28 at bearings +90 degrees and −90 degrees from Final Segment 24, where positive angles represent a clockwise direction.

1. Determine distances from “A” 27 to C1 30 and “A” 27 to C2 32.

a. If “A” 27 is closer to C1 30 then “C” 42 equals C1 30 and a left turn is required to Final Segment 24 defined as “Left Traffic”).

b. Else if “A” 27 is closer to C2 32 then “C” 42 equals C2 32 and a right turn is required to Final Segment 24 (defined as “Right Traffic”).

b. Calculate a point CA 44 (defined as a center point of a turn from “A” 27 to Base Segment 34).

i. Line Base Segment 34 is defined as a bearing and a distance between a point TA 38 and a point T 36.

ii. Point T_estimate 37, defined as an estimation of tangent point T 36, for the purpose of determining the required direction of the turn to the Base Segment 34 from point “A” 27.

1. If “Left Traffic” is true, T_estimate 37 is located at distance RC 48 from point “C” 42 and +90 degrees to bearing of line “A” 27 to “C” 42.

2. Else if “Right Traffic” is true, T_estimate 37 is located at distance RC 48 from point “C” 42 and −90 degrees to bearing of line “A” 27 to “C” 42.

iii. A parameter DH, defined as a direction and a angular magnitude of turn from aircraft position and bearing of aircraft track “A” 27 to point T_estimate 37.

1. Force DH to be a value between −180 and +180 to ensure direction of turn results in shortest angular magnitude.

a. If (DH>180), then DH=DH−360.

b. Else if (DH<−180), then DH=DH+360.

iv. A radius RA 46, defined as a turn radius from “A” 27 to Base Segment 34, based on aircaft velocity VA 62 and predetermined bank angle “B”, where RA 46=VA 62ˆ2/(11.23* tan(0.01745*B)).

v. Location of point CA 44 is determined by a distance RA 46 from point “A” 27 and an angular displacement from bearing of aircraft track at point “A” 27 where,

1. If DH<0, CA 44 is −90 degrees from bearing of aircraft track at point “A” 27,

2. Else if DH>=0, CA 44 is +90 degrees from bearing of aircraft track at point “A” 27.

c. Calculate point T 36, defined as a point where Base Segment 34 is tangent with arc to Final Segment 24, and point TA 38, defined as point where arc from point “A” 27 to “Base Segment 34 is tangent with Base Segment 34.

i. If direction of turn to Base Segment 34 is same as direction of turn to Final Segment 24 (i.e., both left turns or both right turns), then Theta 40=asin(RA 46−RC 48)/(distance of “C” 42 to CA 44).

ii. Else if direction of turn to the Base Segment 34 is the not same as direction of turn to Final Segment 24 (e.g., left turn from “A” 27 to Base Segment 34 followed by right turn from Base Segment 34 to Final Segment 24), then Theta 40=asin(RA 46+RC 48)/(distance of “C” 42 to CA 44).

iii. A location of point T 36, defined as a bearing and a distance from point “C” 42, is determined as follows:

1. Distance of point T 36 from point “C” 42 equal to distance RC 48.

2. If direction of turn from “Base Segment 34” to “Final Segement” is to left, bearing of line “C” 42 to T 36 is defined by bearing of line “C” 42 to CA 44 minus 90 degrees;

a. minus Theta 40 (if direction of turn from “A” 27 to Base Segment 34 is to left), or b. plus Theta 40 (if the direction of turn from “A” 27 to Base Segment 34 is to right)

3. If direction of turn from Base Segment 34 to Final Segment 24 is to right, bearing of line “C” 42 to T 36 is defined by bearing of line “C” 42 to CA 44 plus 90 degrees;

a. minus Theta 40 (if direction of turn from “A” 27 to Base Segment 34 is to left), or

b. plus theta (if direction of turn from “A” 27 to Base Segment 34 is to right)

iv. A location of point TA 38, defined as a bearing and a distance of from point CA 44, is determined as' follows:

1. Distance of point TA 38 from point CA 44 is equal to distance RA 46.

2. If direction of turn from “A” 27 to Base Segment 34 is to left, bearing of line CA 44 to TA 38 is defined by bearing of line “C” 42 to CA 44 minus 90 degrees minus Theta 40.

3. If direction of turn from “A” 27 to Base Segment 34 is to right, bearing of line CA 44 to TA 38 is defined by bearing of line “C” 42 to CA 44 plus 90 degrees plus Theta 40.

3. Shortest flyable path to Target Point 10, DistToRW 58, from “A” 27 to RW 23 is defined as sum of:

a. Arc distance of turn from “A” 27 to TA 38, equal to (absolute difference of bearing at point “A” 27 and bearing at bearing at TA 38)×(PI/180)×RA 46 plus,

b. Distance of Base Segment 34, TA 38 to T 36 plus,

c. Arc distance of turn from T 36 to FP1 28 equal to absolute difference of bearing at point T 36 and bearing at bearing at FP1 28)×(PI/180)×RC 48 plus,

d. Distance from FP1 28 to RW 23

4. Calculate a Distance required to dissipate speed 12, DistToSlow 52, defined as distance required to decelerate from predetermined speed VA 62 to another predetermined speed VC 60 based on actual aircraft performance characteristics at predetermined thrust settings, drag configurations and ambient conditions.

a. DistToSlow 52=((VA 62−VC 60)/Deceleration Rate 64), where Deceleration Rate 64 is obtained from a predetermined aircraft performance database.

5. Calculate a Distance required to dissipate altitude 20, DistToDescend 54, defined as distance required to descend from predetermined altitude (aircraft altitude at point “A” 27) to another predetermined altitude (altitude at point FP1 28, defined as predetermined elevation of FP1 28 plus elevation of RW 23) based on actual aircraft performance characteristics at predetermined thrust settings, drag configurations and ambient conditions.

a. DistToDescend 54=(((Altitude at “A” 27)−(Altitude at FP1 28))/Descent Gradient 66), where Descent Gradient 66 is obtained from predetermined aircraft performance database.

6. Energy Index 50, EI 51, is defined as a comparision of Shortest flyable path to Target Point 10 distance to Target Point 18 and Distance required to dissipate speed 12 and Distance required to dissipate altitude 20 in comparison with descent and deceleration requirements necessary to establish predetermined flight conditions at predetermined point FP1 28.

a. EI 51=(((DistToSlow 52+DistToDescend 54+Target_Dist 56)/DistToRW 58)*100)−100, where Target_Dist 56 equals the distance from point FP1 28 to point RW 23.

7. Tangible Scaling 16 and format of EI 51.

a. One embodiment as expressed above, provides Energy Index 50, EI 51, as a percentage, where EI 51 equal to 100 describes a state where distances required to descend and decelerate equal minimum flyable distance to the Runway 22.

b. Another embodiment subtracts 100 from above EI 51 equation, where EI 51 equal to zero describes state where distances required to descend and decelerate equal minimum flyable distance to the Runway 22.

c. Another embodiment assigns predetermined maximum values of EI 51 correspond to predetermined maximum deceleration and descent configurations for specific aircraft as determined by predetermined aircraft performance data.

d. Another embodiment provides output of EI 51 in digital format for human and computer interface.

e. Another embodiment provides output of EI 51 in analog format for human and computer interface.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of determining a comparison of an aircraft's performance capabilities with performance requirements for monitoring and managing the descent, deceleration, and lateral maneuvering of an aircraft in preparation for a stabilized approach to a landing comprising:
means for providing the distance required to dissipate a predetermined altitude to another predetermined altitude at a target point based on the descent characeristics of an aircraft under ambient conditions (e.g., altitude, wind speed, wind direction, air temperature) and aircraft device configurations (e.g., flaps, slats, speed brakes, landing gear, anti-ice) means for providing the shortest flyable path to a target point which yields the highest possible energy index as well as the most efficient fligh path, independent of any planned or programmed flight path;
means for providing the distance required to dissipate a predetermined speed to another predetermined speed at a target point based on the deceleration characeristics of an aircraft under ambient conditions (e.g., altitude, wind speed, wind direction, air temperature) and aircraft device configurations (e.g., flaps, slats, speed brakes, landing gear, anti-ice);
means for providing a comparison of distance required to dissipate the difference between the current speed and altitude with a target speed and altitude;
means for providing tangible scaling of displayed energy indicies such that cardinal values of an energy index correspond to configuration of aircraft devices (e.g., speed brakes, landing gear, flaps) and recognizable parameters (e.g., speed, altitude, distance); and
means for determining a target point comprising of a geographic position and altitude established by a predetermined course, distance and height from a predetermined runway, independent of any previously determined flight path, and further comprising of a predetermined velocity and predetermined aircraft device configuration.

2. The method of determining a comparison of an aircraft's performance capabilities with performance requirements in accordance with claim 1, wherein said means for providing the distance required to dissipate a predetermined altitude to another predetermined altitude at a target point based on the descent characeristics of an aircraft under ambient conditions (e.g., altitude, wind speed, wind direction, air temperature) and aircraft device configurations (e.g., flaps, slats, speed brakes, landing gear, anti-ice) comprises a distance required to dissipate altitude.

3. The method of determining a comparison of an aircraft's performance capabilities with performance requirements in accordance with claim 1, wherein said means for providing the shortest flyable path to a target point which yields the highest possible energy index as well as the most efficient fligh path, independent of any planned or programmed flight path comprises a shortest flyable path to target point.

4. The method of determining a comparison of an aircraft's performance capabilities with performance requirements in accordance with claim 1, wherein said means for providing the distance required to dissipate a predetermined speed to another predetermined speed at a target point based on the deceleration characeristics of an aircraft under ambient conditions (e.g., altitude, wind speed, wind direction, air temperature) and aircraft device configurations (e.g., flaps, slats, speed brakes, landing gear, anti-ice) comprises a distance required to dissipate speed.

5. The method of determining a comparison of an aircraft's performance capabilities with performance requirements in accordance with claim 1, wherein said means for providing a comparison of distance required to dissipate the difference between the current speed and altitude with a target speed and altitude comprises an a comparison of an aircraft's ability to dissipate speed and altitude, with deceleration and descent requirements necessary to obtain a desired speed, altitude and aircraft device configuration.

6. The method of determining a comparison of an aircraft's performance capabilities with performance requirements in accordance with claim 1, wherein said means for providing tangible scaling of displayed energy indicies such that cardinal values of an energy index correspond to configuration of aircraft devices (e.g., speed brakes, landing gear, flaps) and recognizable parameters (e.g., speed, altitude, distance) comprises a tangible scaling.

7. The method of determining a comparison of an aircraft's performance capabilities with performance requirements in accordance with claim 1, wherein said means for determining a target point comprising of a geographic position and altitude established by a predetermined course, distance and height from a predetermined runway, independent of any previously determined flight path, and further comprising of a predetermined velocity and predetermined aircraft device configuration comprises a target point.

8. A method of determining a comparison of an aircraft's performance capabilities with performance requirements for monitoring and managing the descent, deceleration, and lateral maneuvering of an aircraft in preparation for a stabilized approach to a landing comprising:
a distance required to dissipate altitude, for providing the distance required to dissipate a predetermined altitude to another predetermined altitude at a target point based on the descent characeristics of an aircraft under ambient conditions (e.g., altitude, wind speed, wind direction, air temperature) and aircraft device configurations (e.g., flaps, slats, speed brakes, landing gear, anti-ice);
a shortest flyable path to target point, for providing the shortest flyable path to a target point which yields the highest possible energy index as well as the most efficient fligh path, independent of any planned or programmed flight path;
a distance required to dissipate speed, for providing the distance required to dissipate a predetermined speed to another predetermined speed at a target point based on the deceleration characeristics of an aircraft under ambient conditions (e.g., altitude, wind speed, wind direction, air temperature) and aircraft device configurations (e.g., flaps, slats, speed brakes, landing gear, anti-ice);
an a comparison of an aircraft's ability to dissipate speed and altitude, with deceleration and descent requirements necessary to obtain a desired speed, altitude and aircraft device configuration, for providing a comparison of distance required to dissipate the difference between the current speed and altitude with a target speed and altitude;
a tangible scaling, for providing tangible scaling of displayed energy indicies such that cardinal values of an energy index correspond to configuration of aircraft devices (e.g., speed brakes, landing gear, flaps) and recognizable parameters (e.g., speed, altitude, distance); and
a target point, for determining a target point comprising of a geographic position and altitude established by a predetermined course, distance and height from a predetermined runway, independent of any previously determined flight path, and further comprising of a predetermined velocity and predetermined aircraft device configuration.

9. A method of determining a comparison of an aircraft's performance capabilities with performance requirements for monitoring and managing the descent, deceleration, and lateral maneuvering of an aircraft in preparation for a stabilized approach to a landing comprising:
a distance required to dissipate altitude, for providing the distance required to dissipate a predetermined altitude to another predetermined altitude at a target point based on the descent characeristics of an aircraft under ambient conditions (e.g., altitude, wind speed, wind direction, air temperature) and aircraft device configurations (e.g., flaps, slats, speed brakes, landing gear, anti-ice);
a shortest flyable path to target point, for providing the shortest flyable path to a target point which yields the highest possible energy index as well as the most efficient fligh path, independent of any planned or programmed flight path;
a distance required to dissipate speed, for providing the distance required to dissipate a predetermined speed to another predetermined speed at a target point based on the deceleration characeristics of an aircraft under ambient conditions (e.g., altitude, wind speed, wind direction, air temperature) and aircraft device configurations (e.g., flaps, slats, speed brakes, landing gear, anti-ice);
an a comparison of an aircraft's ability to dissipate speed and altitude, with deceleration and descent requirements necessary to obtain a desired speed, altitude and aircraft device configuration, for providing a comparison of distance required to dissipate the difference between the current speed and altitude with a target speed and altitude;
a tangible scaling, for providing tangible scaling of displayed energy indicies such that cardinal values of an energy index correspond to configuration of aircraft devices (e.g., speed brakes, landing gear, flaps) and recognizable parameters (e.g., speed, altitude, distance); and
a target point, for determining a target point comprising of a geographic position and altitude established by a predetermined course, distance and height from a predetermined runway, independent of any previously determined flight path, and further comprising of a predetermined velocity and predetermined aircraft device configuration.
